(19) United States
(12) Patent Application Publication
(10) Pub. No.: US 2014/0121013 A1
(43) Pub. Date: May 1, 2014

(54) INTERACTIVE FANTASY SPORTS GAMING SYSTEM

(71) Applicants: Tim Carson, New London, NH (US); Marissa Fry, New London, NH (US); Thomas Carson, Phoenix, AZ (US); John Clark, Washington, DC (US); Efram Slen, Bethesda, MD (US)

(72) Inventors: Tim Carson, New London, NH (US); Marissa Fry, New London, NH (US); Thomas Carson, Phoenix, AZ (US); John Clark, Washington, DC (US); Efram Slen, Bethesda, MD (US)

(21) Appl. No.: 14/063,599

(22) Filed: Oct. 25, 2013

Related U.S. Application Data
(60) Provisional application No. 61/718,501, filed on Oct. 25, 2012.

(51) Int. Cl. A63F 13/30

(52) U.S. Cl. CPC A63F 13/12
USPC 463/31

(57) ABSTRACT

A computer-based interactive fantasy sports gaming system that enables players to create a fantasy sports team for virtual participation. The fantasy gaming system implements and manages gaming sessions that correspond to and last for a single real-world sporting event. A user-interface is provided to facilitate athlete selection under constraints that limit the overall pool of athlete candidates to just those participating in the corresponding real-world event, and that limit teams to a smaller subset of the athletes participating in the real-world event. The gaming system is fully integrated with social media channels such as, without limitation, Twitter®, Google+®, and Facebook®, through which players can challenge, communicate and play with their friends.

### CROSS-REFERENCE TO RELATED APPLICATION(S)

The present application derives priority from U.S. provisional application Ser. No. 61/718,501 filed 25 Oct. 2012.

### BACKGROUND OF THE INVENTION

1. Field of the Invention

The present invention generally relates to computer-based interactive gaming systems and, more particularly, to an interactive gaming system that enables users to create a fantasy sports team for virtual participation during a single real-world sporting event. The gaming system determines which of the virtual teams has the highest total team score based on the real-world performance of the athletes composing the users' virtual teams at the sporting event, identifies that team as the winner, and provides awards to the winning team.

2. Background of the Invention

Fantasy sports leagues are a popular form of sports entertainment today. Fantasy sports leagues generally correspond to real-life sports leagues, such as fantasy football leagues corresponding to the National Football League (NFL) and fantasy baseball leagues corresponding to Major League Baseball (MLB). Typical fantasy sports leagues involve initial team selections from an entire league of real-world athletes, and require participation over an entire season of the real-world sports league with which it is associated. For example, teams in fantasy football leagues include athletes chosen from among the total of 1,696 players in the NFL, and the fantasy season lasts from just after Labor Day to December. Each fantasy team plays up to sixteen games corresponding to an equal number played during the regular NFL 17-week season. Participation in existing fantasy sports leagues requires a significant investment of time and effort, and endurance.

Users in a typical fantasy sports league receive scores for their fantasy sports teams based on the real-life performance of the athletes on the users' virtual teams during the season. Scoring varies among the different fantasy sports leagues but is generally a function of the real-world statistics of the athletes composing a user's virtual team.

About thirty-five million North American adults will play fantasy sports in 2012. That number could be greatly increased if the barriers to entry were lowered, e.g., if participation were easier, freer of season-long commitments, and more encouraging of fan engagement. Integrating social media technologies will also help to elevate the fan experience and advances in technology will make the game easier than ever to play via mobile devices and “push” notifications.

There has been one known effort to develop a fantasy gaming system operative over a single real-world sporting event. U.S. Pat. No. 5,860,862 by Junkin issued Jan. 19, 1999 shows an interactive gaming system based on an event which is occurring in real time. Participants select a team of athletes prior to the start of the event based on the event roster. Then, while watching the event on an interactive device, the viewer sees a “ticker tape” at the bottom of the screen showing the real time performance score values of the event's athletes, and interactive team results. Participants can trade athletes throughout the event based on athlete values calculated as a result of athlete performance during that event. The present inventors have found that once an event has started it is difficult to allow participants to add/trade athletes or do anything with their team roster based on real-time scoring. The present invention offers a streamlined version of fantasy sports applicable to all organized sports (baseball, football, soccer, basketball, golf, etc.), playable worldwide, with each sport having its own dedicated native mobile, television and computer software applications. The present system provides a single-event fantasy sports game in which athlete values are based on past events (not on the current event), team selection is closed before the event starts, and there is no trading once the event has begun. The fantasy winner is determined purely by how athletes composing the users' virtual teams perform during the single real-world sports event.

### SUMMARY OF THE INVENTION

In accordance with the foregoing objects, the present invention is a computer-based interactive fantasy sports gaming system that enables users to create a fantasy sports team comprised of real-world athletes for virtual participation during a single real-world sporting event. The fantasy gaming system determines which of the virtual teams has the highest total team score based on the real-world performance of the athletes composing the virtual team at that singular sporting event, identifies that team as the winner, and provides awards to the winning team. The interactive fantasy sports system includes a social media component, as well as sponsored in-game advertising and sports fan analytics for advertisers.

The fantasy gaming system implements and manages gaming sessions that correspond to and last for a single real-world sporting event. The fantasy gaming system streamlines the process of athlete selection by users for their fantasy team in two ways: 1) by limiting the overall pool of athlete candidates to just those on the teams that are participating in the corresponding real-world event, rather than any athlete from the entire league; and 2) by reducing the number of athletes allowed on a fantasy team to a smaller subset of the number of players participating in the real-world event, e.g., no more than five athletes per fantasy team for a baseball matchup, versus nine players on a real-world baseball lineup. For example, for a game in which the Red Sox® were playing the Yankees® a user could form a fantasy team only from those athletes who are on the active player rosters in the real-world event for the Yankees or the Red Sox, even if that athlete doesn't start in the game then being played. The fantasy gaming system then dictates how many of those athletes may be selected for each fantasy team. An athlete may be selected for a fantasy team regardless of his or her fielding position, with the exception of football, in which the user is required to select one quarterback and one defense/special teams, but may fill the remainder of his/her team with athletes regardless of their position. Additionally, for a baseball game, instead of choosing a specific pitcher, a user selects a team's entire pitching staff to fill one spot on the user's fantasy team. Similarly, for a football game, a user selects no more than five players (including a quarterback) plus a defense/special teams. By comparison, traditional fantasy football requires participants to select at least one quarterback, two running backs, two wide receivers, a tight end, a kicker, and a defense/special teams for his/her virtual team. The fantasy gaming system eliminates trading, cutting, and signing of athletes. By cutting down on the number of athletes a fantasy team can have, and eliminating many of the limitations imposed on selection of athletes based on their field position, selection and scoring mechanics may be simplified and optimized for a single-event competition and play value increases.

In addition, the gaming system integrates social media channels through which users can challenge and play with their friends, and communicate through their social networks such as Twitter®, Google+®, and Facebook®.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram of an exemplary application service provider (ASP) network for embodying the present method in software form.

FIG. 2 is a screen print of the user login/registration form.

FIG. 3 is a screen print of the user Home page.

FIG. 4 is a screen print of an exemplary Leaderboard.

FIG. 5 (reserved).

FIG. 6 is a screen print of an exemplary game mode selection screen.

FIG. 7 is a screen print of an exemplary game selection screen.

FIG. 8 is a screen print of an exemplary channel selection screen.

FIG. 9 is a screen print of an exemplary opponent selection screen.

FIG. 10 is a screen print of an exemplary athlete selection page.

FIG. 11 is a screen print of an exemplary athlete selection page as per FIG. 10 with a selection made.

FIG. 12 is a screen print of an exemplary game progress screen.

FIG. 13 is a screen print of an exemplary user score sheet.

FIG. 14 is a spreadsheet representation of an exemplary athlete point value calculation made by ASP server 18.

FIG. 15 is a screen print of an exemplary advertiser coupon within a timed mini-game.

### DETAILED DESCRIPTION OF THE PREFERRED EMBODIMENTS

The present invention is a computer-based interactive fantasy sports gaming system that enables users to create a fantasy sports team made up of real-life athletes for virtual participation during a single real-world sporting event. The fantasy gaming system determines which of the virtual teams has the highest total team score based on the real-world performance of the athletes composing the virtual team at that singular sporting event, identifies that team as the winner, and provides awards to the winning team. The fantasy gaming system includes a social media component, as well as sponsored in-game advertising and sports fan analytics for advertisers, sports teams, and others. Avid sports fans can challenge friends via mobile devices or the web to a fantasy game for just a single game. To facilitate this change, the fantasy gaming system streamlines the game in the following ways:

1: the number of athletes allowed on a team is limited to a subset of the number of players in a real-world sports lineup (e.g., just four to five individual athletes as opposed to nine players on a lineup for baseball);
2: the overall pool of athletes is limited to those athletes on the rosters of the two sports teams playing in the specified game, such that users create a custom team roster derived solely from the two opposing teams on the field (traditionally, fantasy team owners may select any player from the league, which can be an excess of 700 or more players). Thus, a user can only form his/her team based on the two sports teams playing in the specified game;
3: the fantasy gaming system includes a short term Player Point Value System (PPVS) that attributes point values to athletes based on their statistical short-term performance over the last few games (e.g., last seven games for baseball and the last two games for American football). This way if an athlete is statistically “hot”, a higher point value is assigned to the athlete, and if the athlete is statistically “slumping” a lower point value is assigned.
4: the fantasy gaming system includes an automatic alternate selection option into the selection/team building process. The user is prompted to select an alternate for each athlete they select for their team, with several options available. When selecting an alternate the options are:

Selecting an alternate from a list of similar or lower point cost athletes

Auto pick/randomizing a selection from a list of similar point cost athletes

No alternate—determines that they want this athlete on their team regardless of starting status;

The fantasy gaming system is herein implemented in the context of an application service provider (ASP) computer network to facilitate client use of the present method in software form.

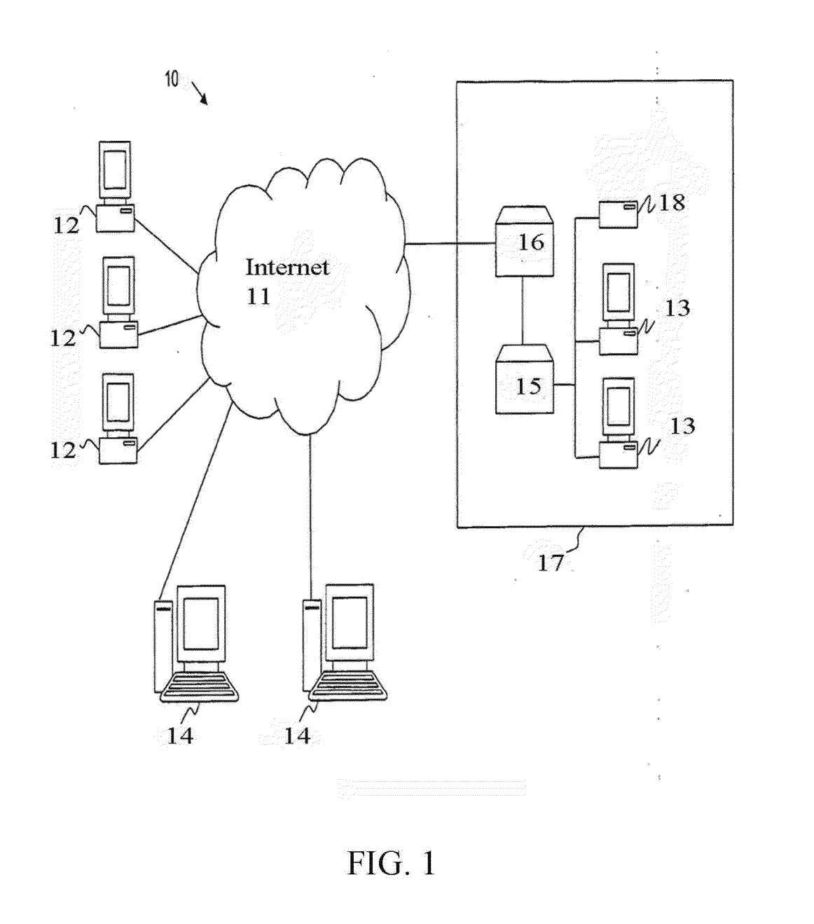

As shown in FIG. 1, ASP network 10 may include a plurality of clients 12 and servers 14 connected via the Internet 11. Any number of clients 12 and servers 14 may participate in such an ASP network 10. The system further includes at least one ASP local area network 17 (LAN) for hosting and allowing administration of the system by administrators using ASP clients 13. The Internet 11 (or World Wide Web) provides a known system for interconnecting clients 12, servers 14 and ASP LAN 17 in a communicating relationship. However, other networks may be used, such as satellite networks, the Public Switched Telephone Network, WiFi networks, WiMax networks, cellular networks, and any other public, private, or dedicated networks that might be used to interconnect devices for transfer of data.

Users will typically access the system via a client 12, which may be any suitable computing device including mobile devices such as laptops, monitors, POS, POI, PDAs, cell phones, tablets (iPAD®, Kindle® Fire®, Google Nexus®, Samsung Galaxy® Tabs, etc.) and the like, or stationery personal computers. Suitable computing devices have an input device, display, processor, memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (DSL) card, cable modem, network interface card, wireless network card, or other interface device capable of wired, fiber optic, or wireless data communications. Client 12 must be equipped with an operating system such as Microsoft Windows®, UNIX, or Linux capable of hosting Internet communication protocols. The client 12 also includes at least one browser program, such as Microsoft Internet Explorer, Google Chrome™, Netscape Navigator™, FireFox™ or the like to provide a user interface for access to the software.

ASP LAN 17 comprises a plurality of ASP clients 13 clustered together through a hub 15 (for example, a peer network such as a wired or wireless Ethernet network) or a local area network server (in, for example, a client-server network).

Secure communication lines are used between clients 12, servers 14 and ASP LAN 17 so that private data remains so. Moreover, the ASP LAN 17 is preferably connected to the Internet 11 through a secure gateway 16 which ensures security of subscriber data as well as operating compatibility between the ASP LAN 17 and the Internet 11.

An exemplary ASP client 13 is a suitable computing device as defined above. The present invention is data intensive, and at least one ASP server 18 in ASP LAN 17 is a database server running database management software to provide database services to ASP LAN 17 and user clients 12 and servers 14, as defined by the ASP client-server model. Database management systems (DBMSs) frequently provide database server functionality, and some DBMSs (e.g., MySQL) rely exclusively on the client-server model for database access. Thus, ASP server 18 preferably hosts a network database preferably an SQL server database, running MySQL. Other examples of Database servers are Oracle, DB2, Informix, Ingres, SQL Server, and cloud computing (AWS®, Anexia®, Heroku®, etc.).

The secure gateway 16 may be a Citrix Access Gateway® for securing the delivery of data and populating data to user ASP clients 13 and servers 14 anywhere. Secure gateway 16 provides security to the ASP LAN 17 and ensures operating compatibility between the ASP LAN 17 and the Internet 11.

The ASP server 18 hosts a hosts a web server which delivers a user interface (UI) having data-entry capability by transmitting web pages in hypertext markup language (HTML) or extensible markup language (XML) (or a similar scheme) using the hypertext transport protocol (http) to any of clients 12, ASP clients 13 or servers 14. To further facilitate this, the ASP server 18 may download a rich Internet application (RIA) plugin or a Java-API executable application to clients 12 and ASP clients 13 that can be executed from within their browser.

The software method of the invention, delivered through the foregoing network, enables individuals to register as users, and thereafter login, selectively create teams and participate in fantasy contests pursuant to the established rules and constraints described herein.

The ASP server 18 also hosts the analytical rules-based decision engine of the present invention, plus a network SQL database which is populated with the outcome statistics from real-world sporting events. When data entry of the user's athlete selections is complete and as the real-world sporting event progresses, the analytical rules-based decision engine subjects the results to a weighted analysis using the SQL database rules, and correlates the test results to a fantasy game. The method of accomplishing this will now be described in detail.

When users visit the site/application, they will see a landing page with marketing content. The home page also invites users to either (i) sign in, which will be applicable to users who have already registered, or (ii) register.

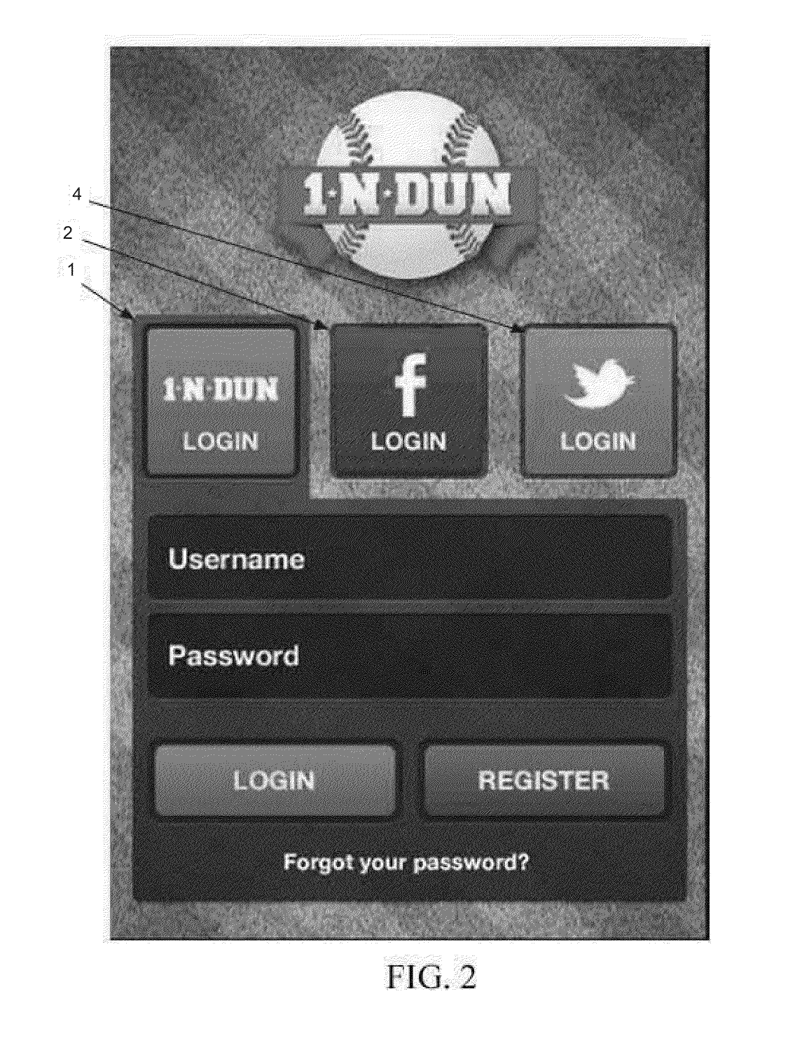

FIG. 2 is a screen print of the user login/registration form. The application is integrated with social media services including Facebook®, Google+®, and Twitter® so that users can share content. The user login/registration form includes file tab social media buttons so that users can Login directly via button 1 or through Facebook button 2 or Twitter button 4. Essentially, the present application authenticates users and then allows the users to grant the application access to their Twitter® or Facebook® accounts so that users can tweet on Twitter® or comment to Facebook®.

When registering as a new user a registration form is completed with personal information (first name, last name, address, phone numbers, etc.), security questions, a security image, requested login ID, password, and email verification. The ASP may send an email to the user with an embedded URL. Clicking the URL will bring the user to the website to complete the registration process.

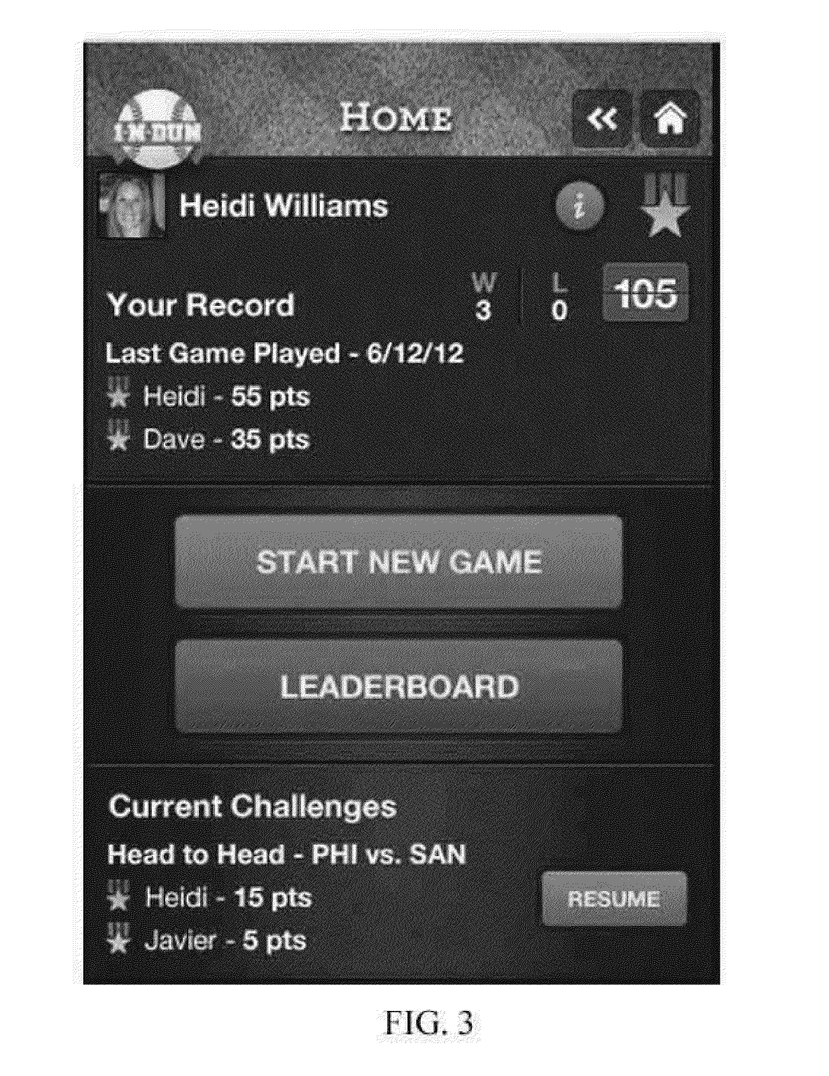

Once properly registered and logged in, the user is presented a Home page. Although the present system is applicable to all organized sports (baseball, football, soccer, basketball, golf, etc.), the Home page is sport-specific and in this case is a baseball version. FIG. 3 is a screen print of the user Home page. The Home page identifies the user by name and image, and presents the user's win/loss record and accumulated point total (here 105). Other statistics may be displayed such as the last game played (Jun. 12, 2012), other user records, etc. At the bottom of the user Home page a listing of current/pending challenges is presented. In this case the user (Heidi) invoked a challenge with Javier based on a Philadelphia versus San Francisco baseball game. The real world game has progressed and Heidi has accumulated 15 points, ahead of Javier's 5 points. At center, the user is presented with the options of Starting a New Game or viewing the Leaderboard. The Leaderboard is a graphical scoreboard that illustrates overall user standings.

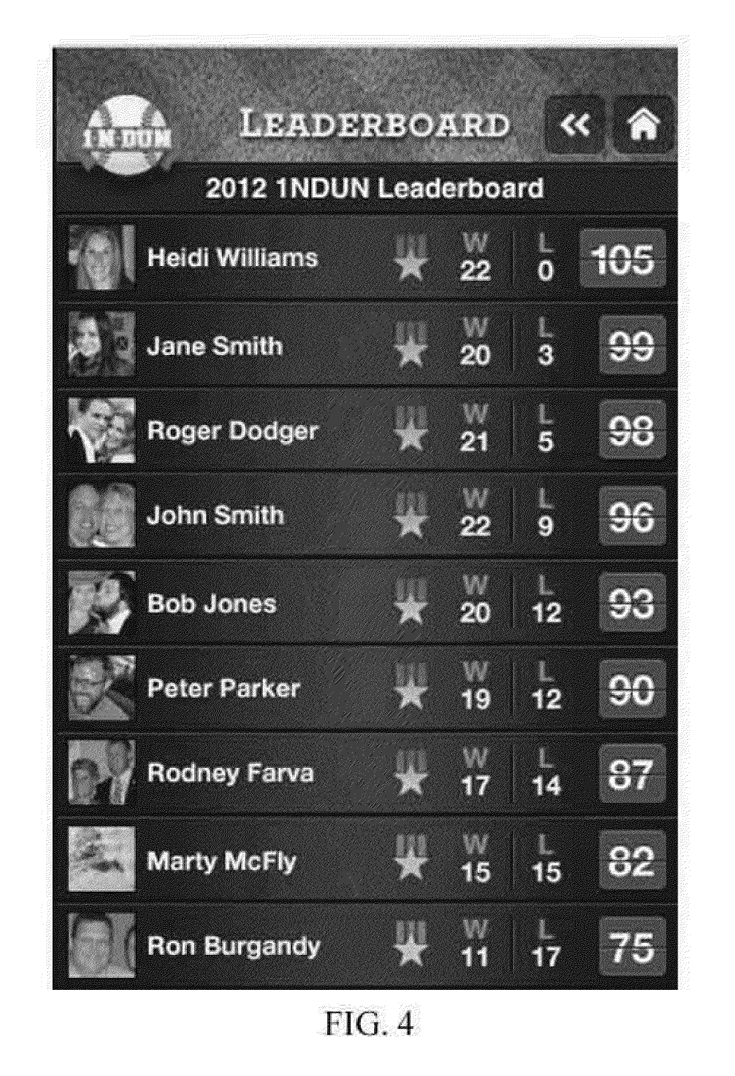

FIG. 4 is a screen print of an exemplary Leaderboard.

Should the user select Start New Game, the system offers several playing formats.

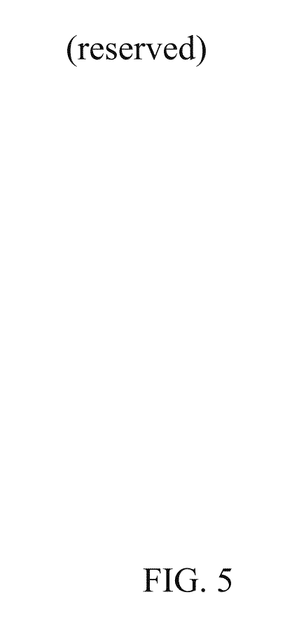

FIG. 5 (reserved)

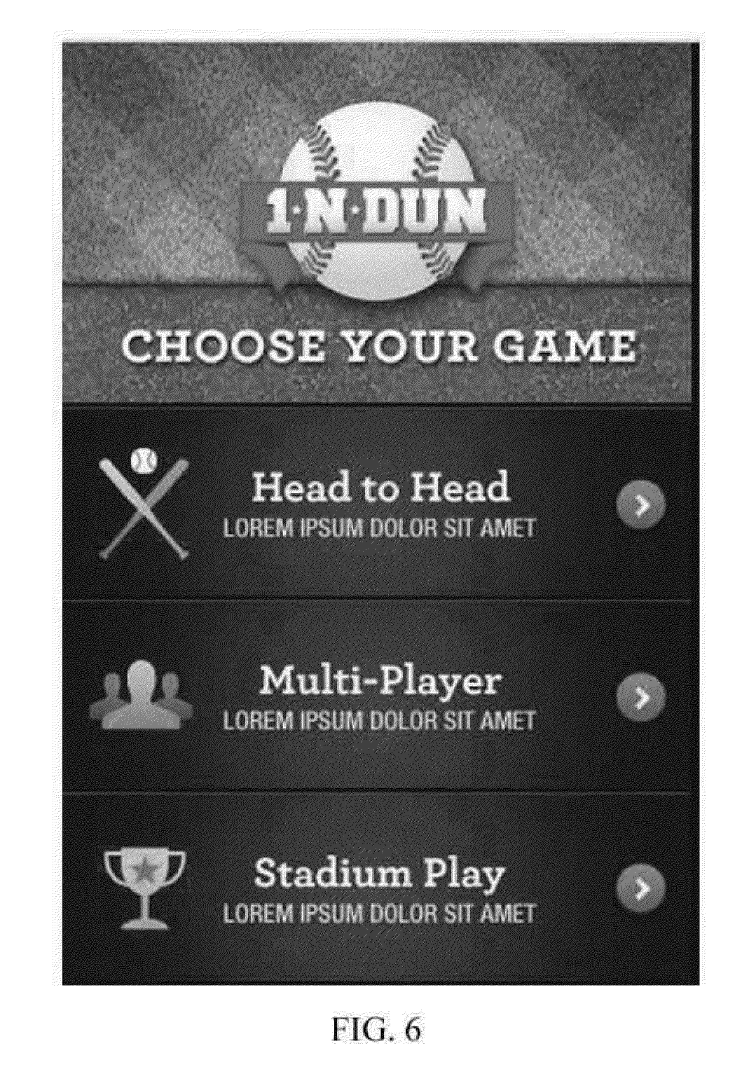

FIG. 6 is a screen print of an exemplary playing format selection page. There are currently three selectable modes of play as described below which provide fantasy users with a way to play multiple competitive formats, including Head-To-Head (one on one), Multiplayer (mini-league of friends), and Stadium Play (Stadium-wide league):

1. Head to Head (H2H): Individual Player vs. Individual Player for One (1) Game

This entails a two-player game and as described above can be initiated through Facebook®, Twitter®, a user's mobile address book, or the ASP player database.

The initiator of the game selects a specific game to play (e.g. Yankees® vs. Red Sox® @ 7 pm ET). The initiator of the game also selects a challenger by inviting another user or selecting a random user to play against. Before the start of the real-world baseball game, each user takes alternating turns to draft up to five real-world athletes from the active rosters of either the Yankees® or the Red Sox® and selects a pitching staff (for the baseball version) to form a virtual team comprising a subset of real-world athletes chosen entirely from the two real-world sporting teams. Once the real-world event starts, the ASP server 18 mines statistics from the game and the two users earn or lose points (as will be described) based on the real-world performances of the athletes on their respective virtual teams.

At the end of the real-world sporting event, the user with the highest point score wins. The user can invite friends (as described above) or play with random users who are also looking for a H2H game.

2. Multiplayer (MP): A Mini League of Multiple Players for 1 Game

Similar to H2H, the MP game can be initiated through Facebook®, Twitter®, a user's mobile address book, or the ASP player database. The initiator of a MP game selects a specific game to play (e.g. Yankees vs. Red Sox @ 7 pm ET). Before the start of the game, the ASP server 18 assigns each real-world athlete competing in the selected game a point-value based on an analytical point-value system (to be described). Unlike H2H mode there is no drafting. In MP mode, each user is assigned a predetermined number of points (e.g., 100 points) with which to select up to five athletes and a pitching staff (for the baseball version) regardless of team affiliation for a specified game. When an athlete is chosen, the athlete's assigned point value is deducted from the user's previously allotted points. The user repeats this process until a user has depleted all of his/her allotted points or has picked the maximum of five (5) athletes allowed and has therefore formed his/her virtual team. Each user then answers three tiebreaker questions. When the real-world game starts users earn or lose points based on the real-world performance of the athletes on the user's virtual team. At the end of the real-world sporting event, the user with the highest point score wins. The user can join a group made up of other registrants or can form a team from known associates (as described above).

3. Stadium Play (SP): Player Vs. Stadium Fans for 1 Game

Unlike H2H and MP modes, SP is initiated through the use of location-based technology. Users “check-in” at a stadium through their smart mobile device for a specific game and can participate in a single stadium-wide virtual fantasy game. Similar to MP mode, before the start of the game, the ASP server 18 assigns each real-world athlete a point-value based on a point-value system (to be described). Each user is assigned a predetermined number of points (e.g., 100 points) with which to select up to five real-world sports athletes and a pitching staff (for the baseball version) regardless of team affiliation. When a user chooses a real-world athlete, the athlete's assigned point value is deducted from the user's previously allotted points. The user repeats this process until a user has depleted all 100 points or has chosen the maximum five (5) athletes allowed and has therefore formed his/her virtual team. Each user then answers three tiebreaker questions, and the game starts. During the game, users earn or lose points based on the real-world performance of the athletes on the user's team. In the stadium mode, high-point winners are showcased in real-time on stadium televisions and Jumbotrons. At the end of the real-world sporting event, high-point earners win prizes and the user who earned the highest amount of points wins a grand prize.

An exemplary Head to Head (H2H) session will now be described to illustrate. After selecting Head-to-Head in FIG. 6, the user is allowed to select a real-world game upon which to base his/her virtual game.

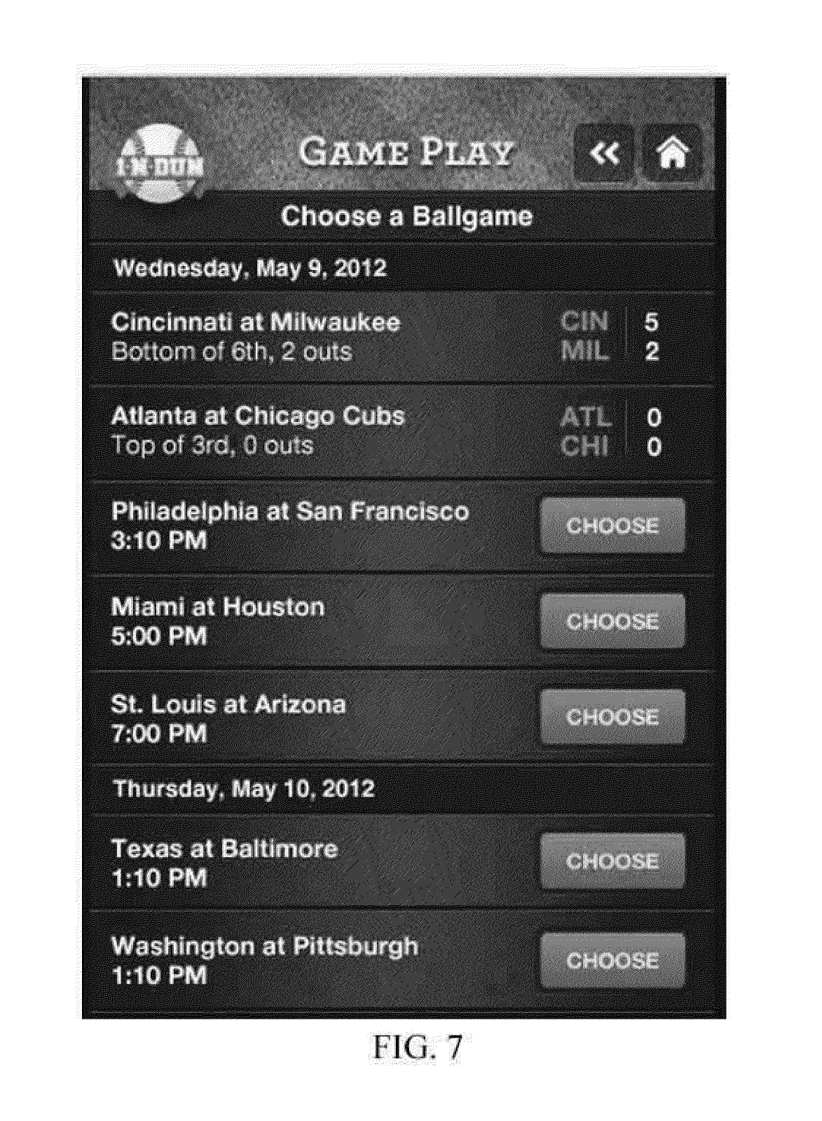

FIG. 7 is a screen print of an exemplary game selection screen, which lists upcoming real-world games in conjunction with “Choose” buttons. The user simply chooses the real-world game upon which to base his/her virtual game. If, for example, the user chooses Philadelphia at San Francisco @3 pm ET, the system progresses to allow the user to choose his/her opponent.

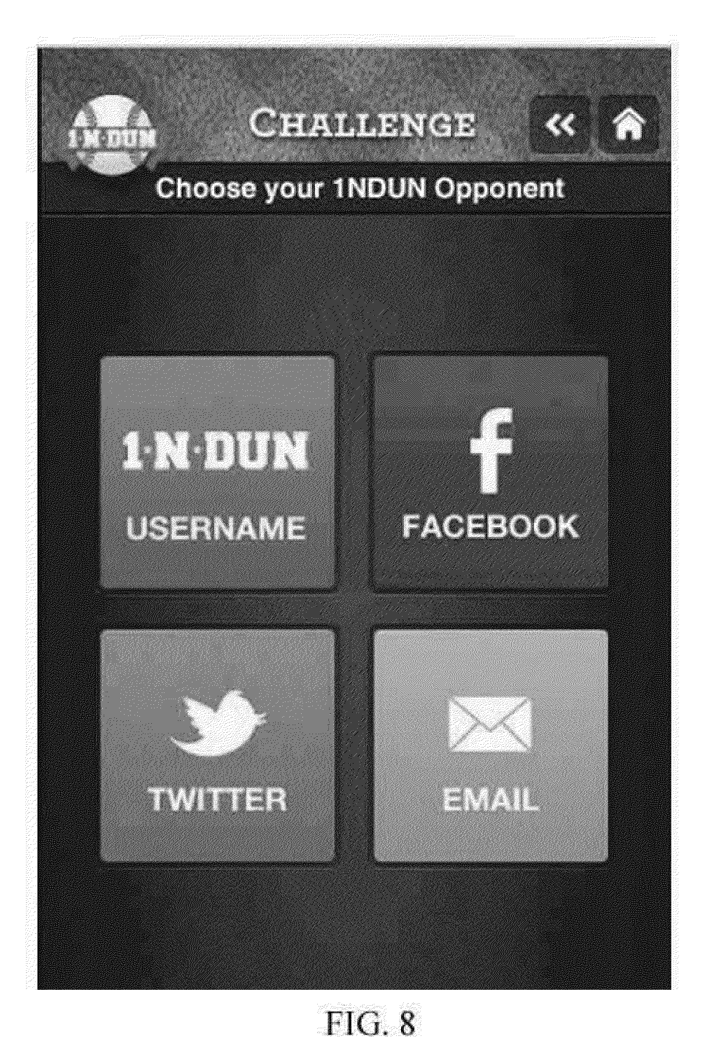

FIG. 8 is a screen print of an exemplary channel selection screen, which presents the choices of selecting an opponent through Facebook®, Twitter®, Email (e.g., a user's Outlook® or other mobile address book), or the ASP player database.

Once a user has selected a channel (Facebook®, Twitter®, Email or ASP player database) for opponent selection, the user is given a listing of available opponents plus choices between one of several methods for opponent selection.

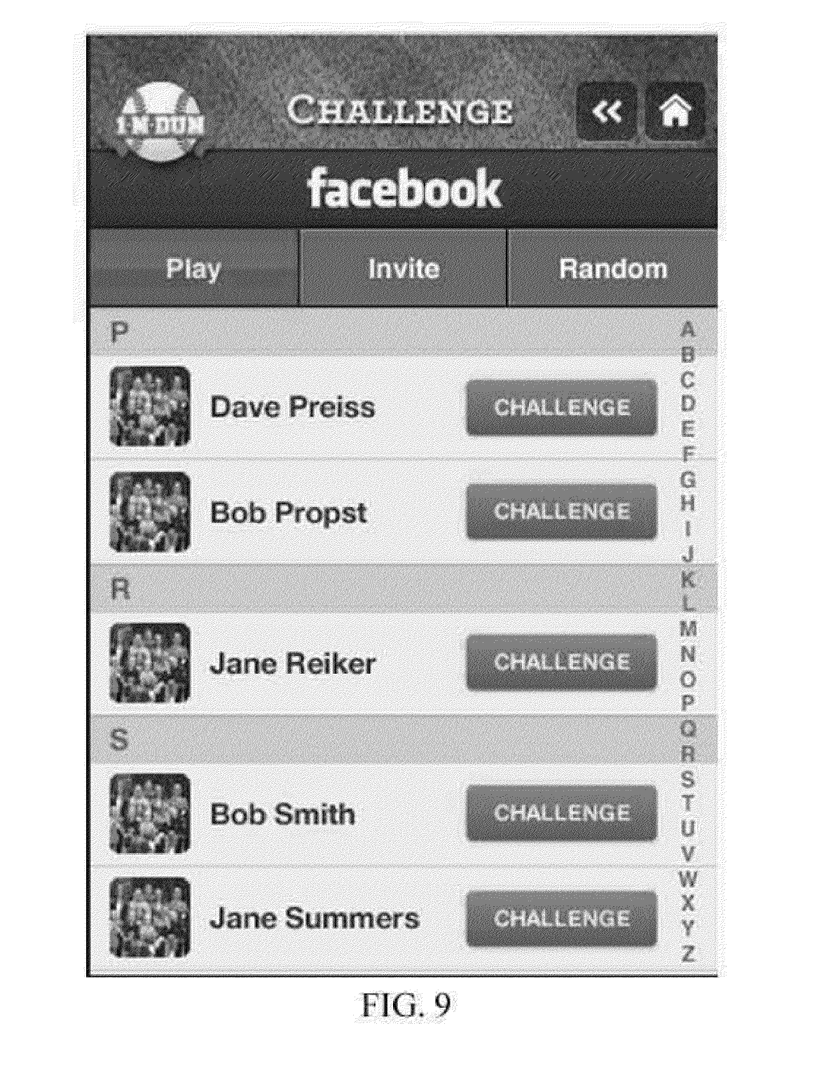

FIG. 9 is a screen print of an exemplary opponent selection screen. At top, the user may select to play an opponent, in which case all opponents available through the selected channel are displayed. The user simply makes an opponent selection. Alternatively, the user may select to invite an opponent to play, in which case all opponents available through the selected channel are displayed. The user issues an invite to a potential opponent selection and the invite is communicated through the selected channel. Alternatively, the user may select a Random assignment, in which case the ASP server makes an opponent selection from the selected channel.

Given opponent selection, the system proceeds to facilitate real-world athlete selection.

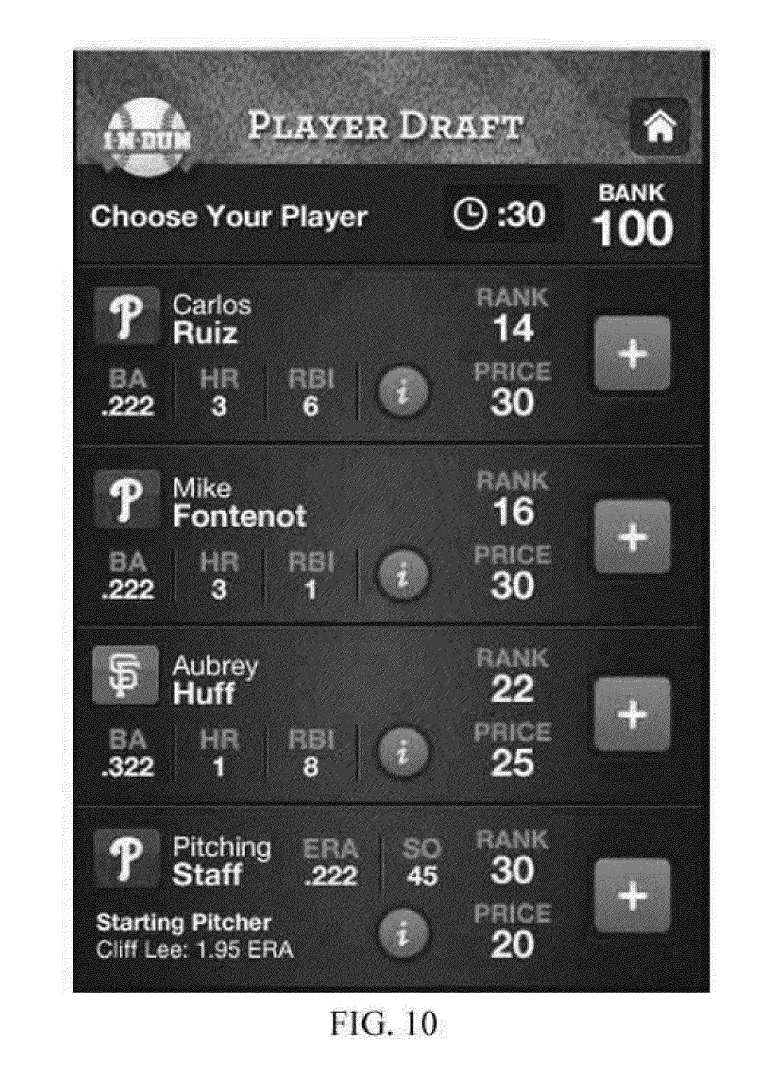

FIG. 10 is a screen print of an exemplary athlete selection page. The athletes available on the pool are listed along with their season statistics and point-value proximate a player selection button [+]. The system arbitrates athlete selection under the constraint that teams must be assembled prior to start of the real-world sporting event. Though selections need not be made immediately, if one of the users delays, reminders may be issued electronically as needed. The time remaining before the real-world event is shown at top.

Each athlete point-value used for initial athlete selection is calculated by a Player Point Value System (PPVS). The function of the PPVS is to assign a point value to individual athletes based on their short-term performance, not season statistics. Thus, the PPVS includes in its weightings, actual and cumulative performance-based statistics of the athlete from the last seven calendar days. The seven-day window of the PPVS accounts for streaks, slumps and the like involved in the athlete's short-term performance. For example, if an athlete did not have more than ten At-Bats (AB) in the last seven days, the PPVS can “weight” the athlete and assign points accordingly. The PPVS also provides the system with the ability to handicap athletes in order to account for outlier statistics. For instance, consider an athlete that enters a game with only three at-bats in the last seven days but has two hits. Without a weighting system (and a designation that this athlete has less than ten at bats in the last seven days), this athlete's point value would be indistinguishable from another athlete that has twenty-two at bats but had fifteen hits in his last seven at-bats. The PPVS properly handicaps this problem.

With reference to PPVS-assigned point values in a Head to Head (H2H)-style challenge, the two opponents take alternating turns to draft up to five sports athletes and to make a pitching staff selection (for the baseball version), thereby forming two smaller-scale virtual teams from the pool of athletes playing in the real-world event.

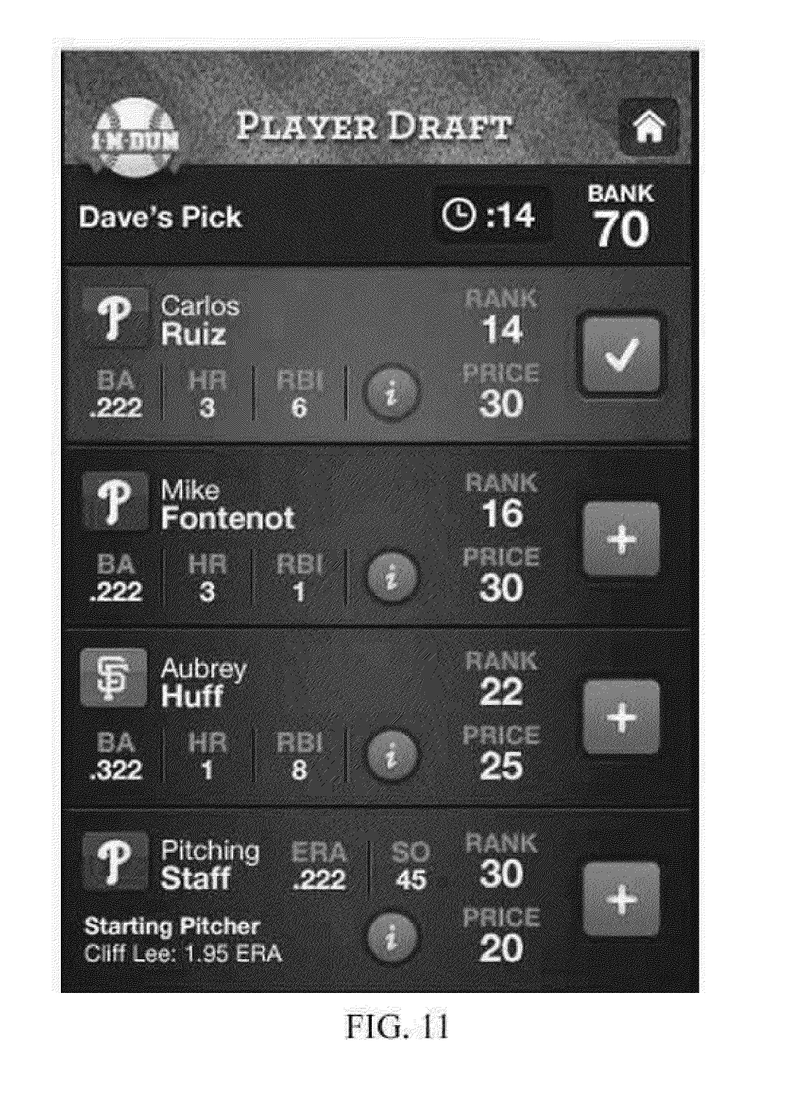

As seen in FIG. 11, users select athletes from the available pool by selecting the corresponding player selection button [+], which is checked after selection is made. Virtual selections may be made regardless of team affiliations for the real-world event. Thus, for example, a user can have a blend of either Red Sox® and Yankees® players, exclusively Red Sox® players, or exclusively Yankees® players.

In addition to the user's primary athlete selections, an alternate is selected for each athlete point category. This avoids the inherent penalty in traditional fantasy sports when a selected athlete ends up not playing due to injury, day-off, late-scratch etc. In the present system users have the option to choose alternates themselves, manually, or to have each alternate auto-selected. Whether by auto- or manual-selection the pool of alternates is still limited to the immediate sports event and each alternate must be in the same tier of PPVS point values as the primary selection or lower point tiers (if athletes in the same point tier are unavailable). For example, on manual selection, if a user selects Mark Texiera but is unsure if he is going to play in the upcoming game because he's been injured, the user can choose Nick Swisher as an alternate and if Mark Texiera doesn't play, then the alternate (Nick Swisher) will be automatically substituted into Mark Texiera's spot on the user's virtual team. If the user chooses to “auto-fill” alternates (the default selection), the PPVS would automatically fill the vacant slot with another athlete, with the same (or lower) point value in the PPVS as the athlete initially selected, at random, regardless of team affiliation. For instance, if a user chose Derek Jeter (30 point value) to start but Derek Jeter scratches and does not play in the upcoming game, on “auto-fill”, the PPVS would select at random another athlete valued at 30 points to fill Derek Jeter's now vacant slot on the user's virtual team. If the user had selected another Yankee 30-point player and did not want a Red Sox athlete chosen for his team should Derek Jeter not start, the user could manually chose another Yankee athlete from all lower tiers (25, 20, 15, 10, and 5).

Because of the small pool of athletes that users have to choose from, the present system employs a number of tiebreaker questions to reduce probabilities of ties between user opponents. Thus, once each user has formed a team, each user then answers three tiebreaker questions (for example for baseball, what are the total number of runs that will be scored by both teams (without going over), the total number of hits, and the total number of strikeouts) before the game starts.

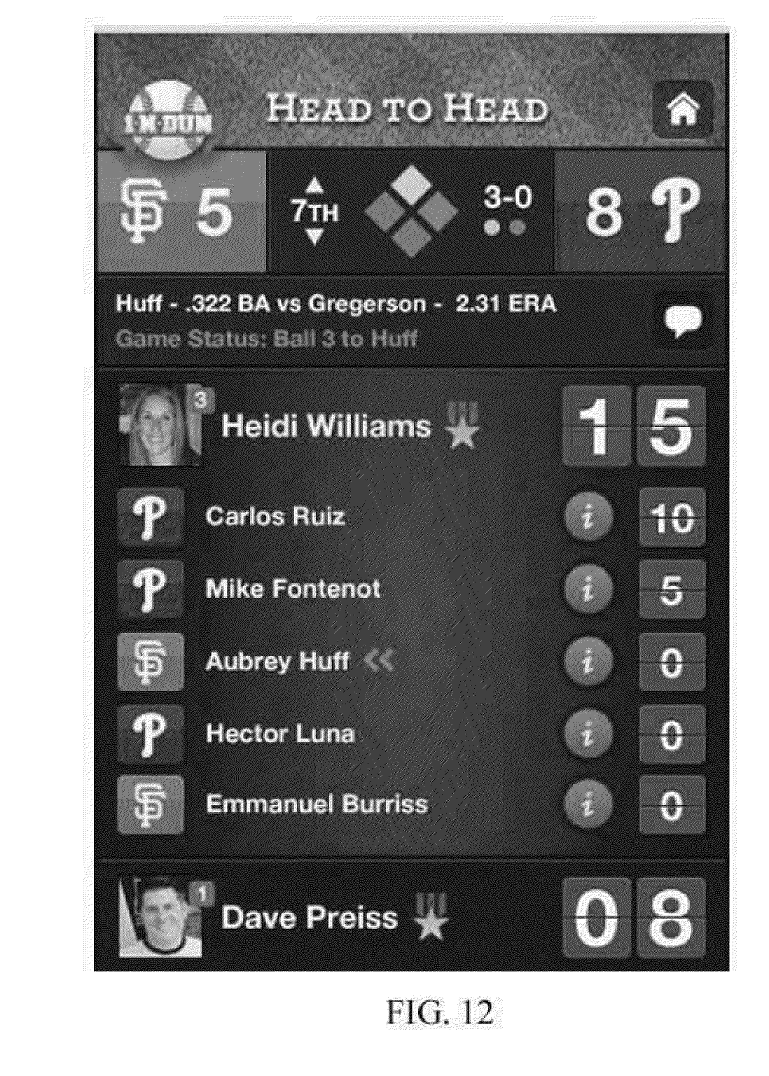

FIG. 12 is a screen print of an exemplary game progress screen. The real-world game progress (score, innings, outs, etc.) is depicted at top, the at-bat details are shown there beneath, and user total point scores as well as individual athlete point scores associated with their respective teams are shown beneath.

During the game, users earn or lose points based on the real-world performance of the athletes on the user's team. Like fantasy sports, a user accumulates points based on the user's virtual team's real-time performance. Each user accrues points based on the real-world actions of the athletes on the user's virtual team as set forth below.

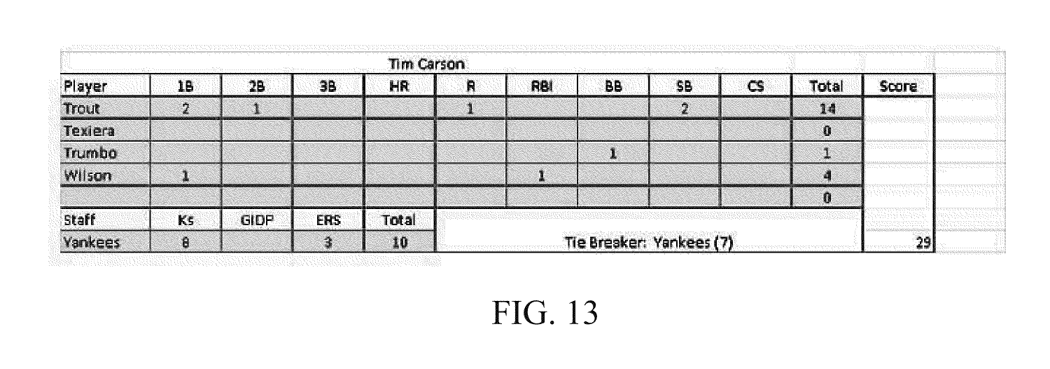

FIG. 13 is a screen print of an exemplary user score sheet for a baseball game in which the user participates. In each type of game, users are awarded points based on the real-world actions of the athletes on their virtual team as follows:

Baseball

Hitters: a single=2 points; a double=4 points; a triple=6 points; a home run=8 points; a run batted in (RBI)=2 points; a run=2 points; a walk=1 point; a stolen base=2 points; a hitter caught stealing=−1 point;

Pitchers: a strikeout=2 points; inducing ground into double play=1 point; and an earned run=−2 points.

Football

Quarterback: 1 point for every 10 yards passed, with a 5 point bonus for over 100 yards passed, a 10 point bonus for over 200 yards passed, and a 15 point bonus for over 300 yards passed. User gets 3 points for every 10 yards run by the quarterback.

Running Back/Wide Receiver/Tight End: 3 points for every 10 yards run/caught, with a 6 point bonus for over 100 yards run/caught, and a 12 point bonus for over 200 yards run/caught.

Each offensive touchdown is worth 6 points. Each two-point conversion scored by an offensive player is worth 2 points.

Defense: Sacks, interceptions, and forced fumbles (regardless of recovery) are worth 1 point each. Defensive touchdowns or Special Teams touchdowns are worth 4 points. A field goal scored by defense or Special Teams is worth 1 point. A safety scored by the defense or special teams is worth 2 points. The user receives the following numbers of bonus points based on the number of points his/her defense surrenders as follows: 0-6 points surrendered=6 points; 7-13 points surrendered=3 points; 14-20 points surrendered=1 point; 21+points surrendered=0 points.

Basketball

Offense: 1 point scored, an assist, or a rebound=5 points; 1 turnover=−5 points; 1 personal foul=−2 points;

Defense: a steal or block=2 points.

Hockey

Goalie: a save=1 point; a goal conceded=−2 points. The user may receive bonus points for the following actions of his/her goalie: a winning goalie gets 5 points, or 10 points for a shutout (0 goals conceded). Additionally, the user receives −1 point for each penalty minute that his/her goalie obtains.

All other players: a goal=10 points; an assist=5 points; each penalty minute=−1 point.

Golf

The user may receive points per golfer per round, over a total of four rounds, for the following actions of the golfers on his/her team: an ace (hole-in-one)=20 points; a double-eagle (3 under par)=8 points; an eagle (2 under par)=4 points; a birdie (1 under par)=2 points; shooting par=1 point; a bogey (1 over par)=−1 point; a double-bogey=−2 points; a triple-bogey=−3 points; a score of 4 over par=−4 points; a score of 5 over par=−5 points; and so on. The user may receive bonus points if his/her golfer: wins the tournament=15 points; finishes in the top five=10 points; finishes in the top ten=5 points.

Formula 1 Automobile Racing

Drivers: 1nDun drivers receive points for “place differential”, which is calculated by taking the driver's starting position (based on official qualifying order) minus his finishing position. 1nDun drivers receive points corresponding to their place differential (as long as the driver finishes the race). Additionally, points are awarded to drivers based on his overall finishing position as follows: 1st place=50 points; 2nd place=49 points; 3rd place=48 points; 4th place=47 points; and so on thru all drivers that finished the race. If a driver Did Not Finish Race (DNF), the driver is penalized −5 points.

The user may receive bonus points for the following: the driver with the fastest lap earns 10 points; and the driver with the fastest pit stop earns 10 points. The same points are awarded to a driver in the championship standings.

Baseball Home Run Derby

Hitters (scores calculated over three rounds): In the first round, a home run=15 points; an outfield hit=5 points; a foul ball=−5 points; and an infield hit=−10 points. In the semi-finals, a home run=20 points; an outfield hit=10 points; a foul ball=−5 points; and an infield hit=−10 points. In the finals, a home run=25 points; an outfield hit=15 points; a foul ball=−5 points; and an infield hit=−10 points.

Soccer

All athletes: a goal=10 points; an assist=5 points; a shot on goal=2 points; a shot=1 point; a foul suffered=2 points; a foul committed=−1 point; a yellow card=−2 points; and a red card=−5 points.

Goalie: a save=2 points; a goal conceded=−4 points. A user receives the following number of bonus points if his/her goalie: concedes 0 goals=10 points; concedes 1 goal=5 points; and concedes 2 goals=2 points.

Cricket

Batsman: a run=10 points; 6s=6 points; and 4s=4 points.

Bowlers: a maiden=100 points; a wicket=50 points; and a run conceded=−1 point.

The ASP server 18 maintains a score sheet for each user inclusive of all selected athletes, on a real-time basis during progress of the corresponding real-world sporting event. Points are accumulated based on the selected athlete's real-world performances in accordance with the foregoing assignments (e.g., for baseball, a single=2 points; a double=4 points, etc.). The calculated point accumulations are fed back to populate the game progress screen (FIG. 12).

One skilled in the art should understand that the point scoring assignments may be adjusted as a matter of design choice.

For Multiplayer (MP) and Stadium Play (SP), the ASP server 18 allocates a predetermined number of credits that users spend in order to obtain athlete selections. Athletes cost more or less depending on an athlete Player Point Value System (PPVS) that attributes point values to athletes based on their past statistical performance. Statistics are ranked over their last seven games for baseball and the last four games for American football. This point scoring system better reflects an athlete's short-term performance during a season. For example, if an athlete is statistically “slumping”, a lower point value will be assigned to the athlete, and vice versa.

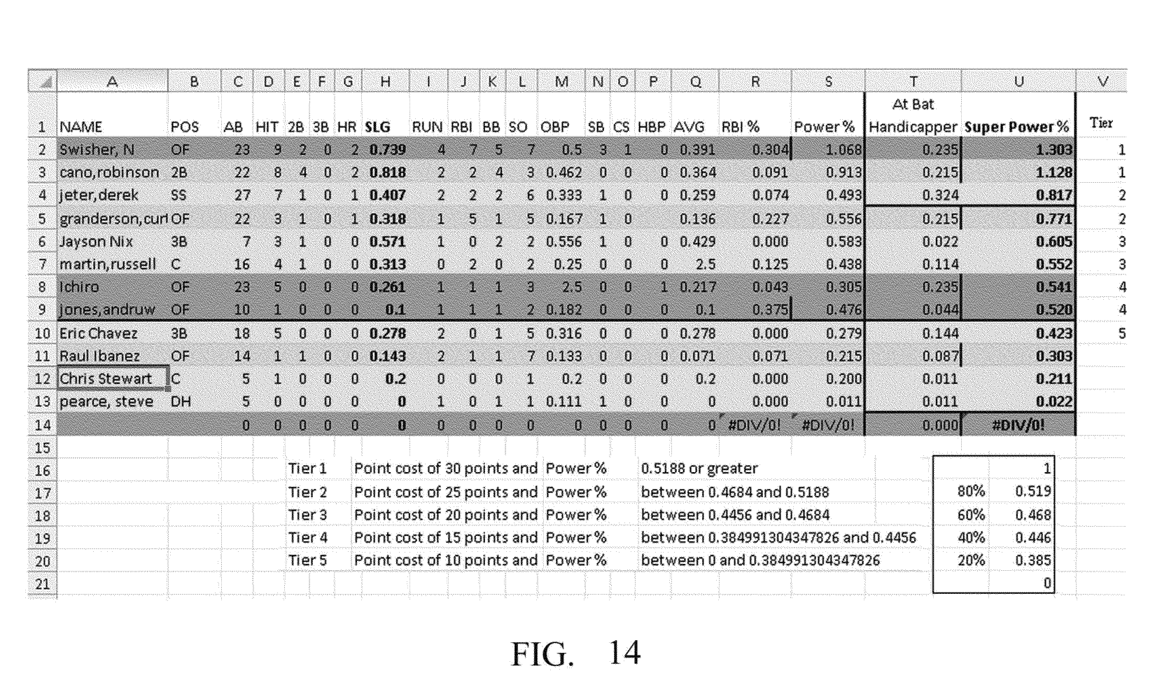

FIG. 14 is a spreadsheet representation of an exemplary athlete point value calculation made by ASP server 18 for a single baseball game, though in use the point value calculation would be made based on these statistics accumulated over the last seven games.

The hitter's formula is based on statistics from the following offensive categories over the previous (from the selected game date) seven days/games: at bats (ABs), hits, 2Bs, 3Bs, home runs (HRs), slugging percentage (SLG), runs, runs batted in (RBIs), walks (BB), strikeouts, on base percentage, stolen bases (SB), caught stealing (CS), hit by pitch, and batting average. A runs batted in ratio (RBI %) is calculated by dividing runs batted in (RBIs) with at bats (AB). The athlete's slugging percentage (SLG) is summed with RBI %, and to this is added a weighted component of walks (BB), (BB/1000), and a weighted component of Stolen bases (SB) minus caught stealing (CS), [(SB−CS)/100]. The result is coined “Power %.”

An “At Bat Handicapper” is then applied to the Power % by multiplying a function of at-bats (here the square of 20% of at-bats (AB/5)² divided by ninety). The At Bat Handicapper is then summed with the Power % to yield a “Super Power %”, which is used to rank and value the athletes. As indicated above the At Bat Handicapper handicaps athletes upward or downward for more or less at-bats, helping to distinguish more credible statistics. The athletes are ranked in tiers based on Super Power %, and either a fixed-point cost or a traditional bell curve is assigned to each tier. The tier calculations and the fixed point-point costs are as follows:

Fixed Point Tiers

Tier 1: point cost of 30 points=Power % 0.5188 or greater;

Tier 2: point cost of 25 points=Power % between 0.4684 and 0.5188;

Tier 3: point cost of 20 points=Power % between 0.4456 and 0.46848;

Tier 4: point cost of 15 points=Power % between 0.385 and 0.4456;

Tier 5: point cost of 10 points=Power % between 0 and 0.45.

Bell Curve Tiers

Those athletes with skill scores in the top 7.5% receive a point cost of 30 points; from 7.5% to 15% receive a point cost of 25 points; from 5% to 25% receive a point cost of 20 points; from 25% to 40% receive a point cost of 15 points; from 40% to 60% receive a point cost of 10 points; and from 60% to 100% receive a point cost of 5 points.

Athlete cost is assigned accordingly (for hitters in baseball).

The pitching rotation formula is based on statistics of the following defensive categories over the previous (from the selected game date) seven days/games: earned run average, strikeouts, wins-losses, inducing double-plays (GIDP). Pitcher costs are calculated in a similar fashion to hitter costs.

This tiering structure is shown at the bottom of FIG. 14. Each user must pick at least four athletes and 1 pitching staff within their allotted (e.g., 100) points. However, if a user has points left over they may optionally choose a fifth athlete. The ASP server 18 tracks selected athletes and tallies point cost.

After the user selects his/her team and confirms selection (“Continue”), they will be asked to answer a series of three tie-breaker questions by guessing the following values: total score of selected game (Team A score+Team B score); total number of hits in the selected game (Team A hits+Team B hits); and total number of strikeouts in the selected game (Team A strikeouts+Team B strikeouts).

The above-described system derives operating revenue from three primary sources: premium-level (Stadium Play) bookings, sponsored in-game advertising, and sports fan mobile analytics.

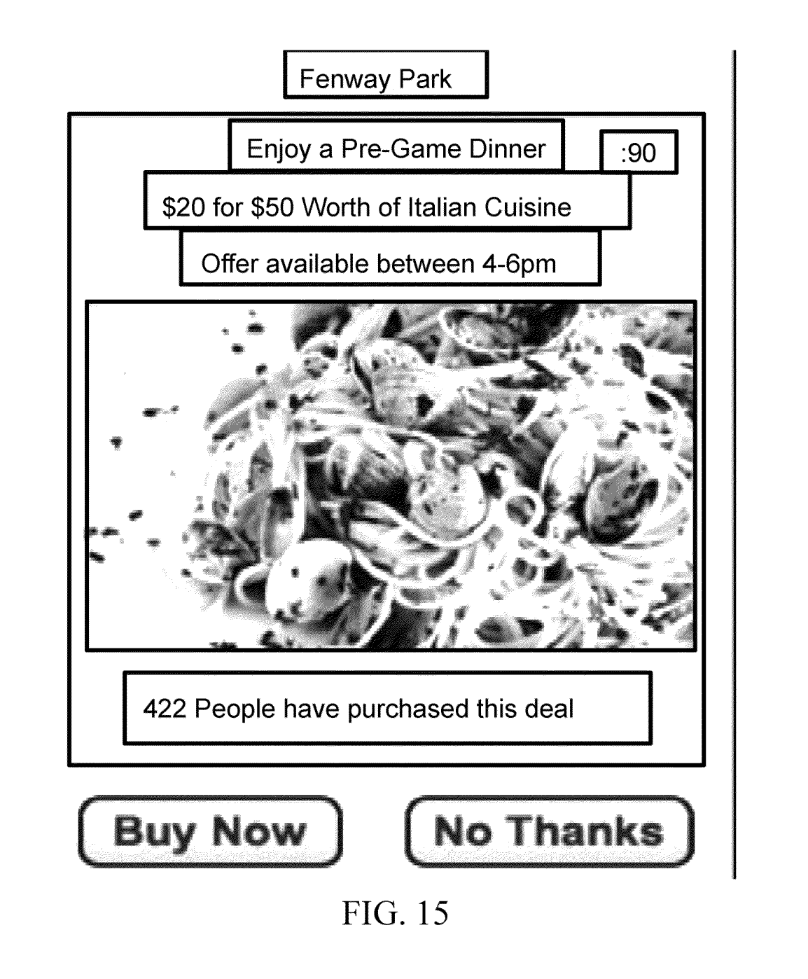

Sponsored in-game advertising is unique in that it is designed to increase user engagement during downtimes of a real-world game. The sponsored in-game advertising comprises a short mini-game played by a user during downtimes. For a fee, a sponsor may offer a short timed-game to a user to complete for additional points to a user's overall point score. If the timed game is not completed in the allotted time, then no points are added to the user's overall point score. Alternatively, a user or advertiser may select to receive a coupon or exclusive deal from the mini-game's sponsor for participation in the mini-game. Such coupons or deals may include short-term discounts on the sponsor's goods or services, and businesses that are physically located near the arena where the real-world game is played, such as for SM challenges, may choose to promote specials or award coupons to attendees of the real-world game through the mini-games within the fantasy gaming system. Sponsors may also choose to offer an outside application for download through the mini-game if the user so chooses. FIG. 15 is a screen print of an exemplary advertiser coupon within a timed mini-game. Examples of mini-games may include word scrambles, other puzzles, or trivia contests. Such sponsored in-game advertising mini-games are delivered via the above-described user interface at times selected by the ASP server 18 and may be skipped by the user, if desired.

“User Analytics” means all usage data, reports, statistics, and analyses thereof compiled by the ASP server 18 based on user website activity. The server 18 analyzes user analytics to arrive at statistically sound predictions of future behavior including web impression, click, and action data. The output of this analysis allows the ASP to offer sport dashboard solutions and metrics data to sports franchise owners and other entities.

The above-described system allows users to play multiple games in multiple formats against multiple other users, concurrently. As previously noted, users have the ability to compete with other users in three formats—H2H, MP and SP, and may do so for any number of games in a given day. Thus, for example, John Doe can initiate a game with Jane Doe in H2H mode for the Yankees vs. Red Sox game, can simultaneously initiate a game with Donald Doe in MP mode, and if John were physically at the game he can also join the stadium league in SP mode. Meanwhile, Jane can simultaneously play the Giants vs. Diamondbacks. In short, a user can participate in a large portfolio of fantasy games concurrently, limited only by three variables: the participant's network (Smart Phone contact database/Facebook®/Twitter® or other network and availability of other 1nDun players seeking to play strangers), the number of games in a given day, and the three modes of play. This greatly increases the play value for users as well as the value of the user metrics returned by the system.

The above-described fantasy sports system is readily adapted to a variety of other sports as follows:

A. Home Run Derby

### Overview

Users form four-athlete teams from the total pool of eight athletes that participate in the home run derby. Points are accrued, or subtracted, according to how the athletes perform as they advance through three rounds. The team with the most points at the end of the third round (“Finals”) wins the game. Tiebreakers are decided according to the following factors: 1) users predicting the total number of home runs scored for certain pre-selected athletes; and 2) users predicting which athlete will have the fewest home runs. The user that comes closest to the pre-selected athlete's final home run total and picks the athlete with the fewest home runs wins the tiebreaker. Like fantasy baseball a user accumulates points based on the user's team's real-time performance.

### Athlete Selection

There is no PPVS. All athletes have equal value. Users are required to select four athletes for their team from a pool of eight athletes from the American League and the National League.

### Scoring

Each user can accrue points based on the following actions for the athletes on users' respective teams:

| Basic | POINTS | | |
|---|---|---|---|
| Scoring | 1st Round | Semifinal Round | Final Round |
| HR | 15 | 20 | 25 |
| Outfield Hit | 5 | 10 | 15 |
| Foul Ball | −5 | −5 | −5 |
| Infield Hit | −10 | −10 | −10 |

| Bonus Scoring | Points | Bonus Scoring | Points |
|---|---|---|---|
| 3 consecutive HRs | +10 | 401-425 feet | +5 |
| 4 consecutive HRs | +20 | 426-450 feet | +10 |
| 5 consecutive HRs | +30 | 451-475 feet | +20 |
| | | >475 feet | +30 |

B. NBA Basketball

### Player Point Value System (PPVS)

Point values are based on athlete statistical performance over the last fifteen games. The PPVS formula is as follows:

((((P*3)+(R+A))+(2*(S+B)))/((10+(2*TO))+PF))*10

where: P=number of points; A=number of assists; R=number of rebounds; TO=number of turnovers; PF=number of personal fouls; S=number of steals; and B=number of blocks.

### Athlete Selection

Given a starting bank of 100 points per user, users are required to select a minimum of five athletes and an optional sixth athlete. Athletes have a Point Cost allocated based on the PPVS according to the following ranking formula:

PPVS Score greater than 85%=point cost of 30 points;
PPVS Score between 75% and 85%=point cost of 25 points;
PPVS Score between 55% and 75%=point cost of 20 points;
PPVS Score between 40% and 55%=point cost of 15 points;
PPVS Score between 20% and 40%=point cost of 10 points;
PPVS Score less than 20%=point cost of 5 points.

### Scoring

A user accumulates points based on the user's team's real-time performance. Each user can accrue points based on their athlete's following actions:

Offense: 1 point scored=5 points; 1 assist=2 points; 1 rebound=2 points; 1 turnover=−5 points; and 1 personal foul=−2 points. Defense: 1 steal=2 points; and 1 block=2 points.

As above each game has a winner, but points accumulate and there can also be winners for an entire series (e.g., a seven game “playoff”).

C. March Madness Basketball

### Player Point Value System (PPVS)

Same as as above for NBA BASKETBALL.

### Athlete Selection

The March Madness variation allows users to choose individual NCAA basketball athletes from each team that is invited to the NCAA Tournament. This allows the user to pick individual players from teams in each region (rather than picking which teams are going to advance to the next round) to see who has the high score cumulatively over the different rounds to the finals.

### Round 1 (Round of 64):

In the first round (64 teams), the user can pick 5 to 6 athletes per region (i.e. east/west/north south) or a total of 4 fantasy teams each with 5-6 athletes.

### Round 2 (Round of 32):

In the second round (32 teams), the user can pick 5 to 6 athletes per region (i.e. east/west/north/south) or a total of 4 fantasy teams each with 5-6 athletes.

### Round 3 (Round of 16; “Sweet Sixteen”):

In the third round (16 teams), the user can pick 5 to 6 athletes from the teams per region (i.e. east/west/north/south) or a total of 4 fantasy teams each with 5-6 athletes.

### Round 4 (Round of 8; “Elite 8”):

In the fourth round (8 teams), the user can pick 5 to 6 athletes per side of the bracket (i.e. north/west and east/south) or a total of 2 fantasy teams each with 5-6 athletes.

### Round 5 (Round of 4; “Final Four”):

In the fifth round (4 teams), the user can pick 5 to 6 athletes per side of the bracket (i.e. north/west and east/south) or a total of 2 fantasy teams each with 5-6 athletes.

### Round 6 (Round of 2; “The Final”):

In the sixth round (2 teams), the user can pick 5 to 6 athletes from the two teams left or a total of 1 fantasy team with 5-6 athletes.

As per football, an alternate selection option is used.

### Scoring

Points accumulate each day. For each round, the user with the highest number of points wins that round, and a user with the highest number of points after all six rounds wins the tournament.

D. Hockey

### Player Point Value System (PPVS)

Hockey athlete PPVS is based on statistical performance of the athlete in his/her last month's worth of games. The goalie skill score is calculated as follows:

((WIN*5+SHO*10+SV)−(TGA*2))/10*(SV %)*3

where each of the following are the aggregate statistics for the preceding month: WIN=the number of wins the goalie's team achieved; SHO=the number of shutouts the goalie succeeded in obtaining; SV=number of saves; TGA=total goals allowed; and SV %=save percentage, determined by dividing the number of saves by the number of shots taken on goal (the number of saves plus number of goals allowed).

All other players skill scores are calculated as follows:

(10*G+5*A+PTS*2)/(10+PIM)*5

where each of the following are the aggregate statistics for the preceding month: G=goals; A=assists; PTS=points; and PIM=penalty minutes.

### Athlete Selection

Given a starting bank of 100 points per user, users are required to select a minimum of five athletes and an optional sixth athlete. Athletes have a Point Cost according to the following ranking formula:

PPVS in the top 7.5%=point cost of 30 points;
PPVS in the top 7.5% to 15%=point cost of 25 points;
PPVS in the top 15% to 25%=point cost of 20 points;
PPVS in the top 25% to 40%=point cost of 15 points;
PPVS in the top 40% to 60%=point cost of 10 points;
PPVS in the top 60% to 100%=point cost of 5 points.

### Scoring

Each user can accrue points based on their athletes' following actions:

Goalie: a save=1 point; a goal conceded=−2 points. The user may receive bonus points for the following actions of his/her goalie: a winning goalie gets 5 points, or 10 points for a shutout (0 goals conceded). Additionally, the user receives −1 point for each penalty minute that his/her goalie obtains.
All other players: a goal=10 points; an assist=5 points; each penalty minute=−1 point.

As above each game has a winner, but points accumulate and there can also be winners for an entire series (e.g., a five or seven game “playoff”).

E. Golf

### Player Point Value System (PPVS)

Before the start of a tournament, the field of golfers is calculated based on athlete's season-long performance. The first tournament of the season uses the previous season's statistics for calculating the golfers' rank.

A golfer's PPVS is determined by their skill score, which is calculated as follows:

(SA/3)*(BBR)−(Rank/10)

where SA=scoring average; BBR=birdie-to-bogey ratio; and Rank=the golfer's ranking that week.

While the majority of the golfers in tournament play are on the PGA Tour, and therefore have detailed statistical information gathered and available, there is always a segment of the field that play on other world tours (European, Asian, Aussie, etc.). Non-PGA Tour golfers are assigned the same statistics, when available, as PGA Tour golfers. Senior PGA Tour (Champions) golfers are assigned the same statistics, when available, as the PGA Tour golfers.

### Athlete Selection

Once the Skill Score is calculated, the ranking is determined by the volume and breakout of the whole field. The Point Cost Tiers are then determined on a “curve” from the Skill Score Ranking.

Users start with a bank of 100 points and make selections of athletes (golfers) until their bank is exhausted or a maximum of 5 golfers have been selected. As per football, an Alternate Selection option is used.

### Scoring

Each user can accrue points based on their athlete's following actions: an ace (hole-in-one)=20 points; a double-eagle (3 under par)=8 points; an eagle (2 under par)=4 points; a birdie (1 under par)=2 points; par=1 points; a bogey (1 over par)=−1 points; a double-bogey=−2 points; a triple-bogey=−3 points; etc. The user may receive bonus points if his/her golfer: wins the tournament=15 points; finishes in the top five=10 points; finishes in the top ten=5 points. There can be winners from a single round/day and winners for the entire tournament. Both formats could be run in parallel where a round winner is announced after each of the four rounds and a tournament winner will be determined after the conclusion of the tournament (fourth round). In the event of a tie, a series of tiebreaker questions determine the place winner.

By selecting five golfers who perform well in the tournament, and playing all four rounds of the tournament, users will have the best opportunity to do well and potentially win. The premium on selecting five golfers with the allotted bank, and each golfer playing all four round of the tournament is the point awarded for each par. Users accrue points based on performance, round by round, and by maximizing the opportunity to accumulate those points.

F. Formula 1 Racing

### Player Point Value System (PPVS)

A driver's PPVS is determined by their skill score, which is calculated as follows:

P+(PD*1.5)+(FP/2)−(DNF)+(Bonus)

where P=points; PD=place differential (as set forth below); FP=finishing position; DNF=did not finish (as set forth below); and Bonus=the sum of the bonus points awarded to that driver.

Once the Skill Score is calculated, the ranking is determined by the volume and breakout of the whole field.

### Athlete Selection

The user starts with a bank of 100 points and makes selections of athletes (racers) until their bank is exhausted or a maximum of five athletes have been selected. Alternate selection per above is used. Athlete Point Costs are determined on a “curve” as follows:

PPVS in the top 7.5%=point cost of 30 points;
PPVS in the top 7.5% to 15%=point cost of 25 points;
PPVS in the top 5% to 25%=point cost of 20 points;
PPVS in the top 25% to 40%=point cost of 15 points;
PPVS in the top 40% to 60%=point cost of 10 points; and
PPVS in the top 60% to 100%=point cost of 5 points.

### Scoring

Like most fantasy sports, a user accumulates points based on the user's team's real-time performance. Each user can accrue points based on their driver's following actions:

Drivers: 1nDun drivers receive points for “place differential”, which is calculated by taking the driver's starting position (based on official qualifying order) minus his finishing position. 1nDun drivers receive points corresponding to their place differential (as long as the driver finishes the race). Additionally, points are awarded to drivers based on his overall finishing position as follows: 1st place=50 points; 2nd place=49 points; 3rd place=48 points; 4th place=47 points; and so on thru twenty-two places (the driver must finish the race). If a driver Did Not Finish Race (DNF), the driver is penalized −5 points.

The user may receive bonus points for the following: the driver with the fastest lap earns 10 points; and the driver with the fastest pit stop earns 10 points. The same points are awarded to a driver in the championship standings.

Points are not awarded for qualifying, but qualifying is an integral part of the scoring system where −/+ place differential is calculated (starting position vs. finishing position).

In the event of a tie, tiebreaker questions determine the place winner.

G. Tennis

### Player Point Value System (PPVS)

The PPVS formula is as follows:

WT=(A*5)+(DF*(−2))+(1S*2)+(2S)+(1SR*2)+(2SR)+10

LT==(A*5)+(DF*(−2))+(1S*2)+(2S)+(1SR*2)+(2SR)

where WT=winner total; LT=loser total; A=number of aces; DF=number of double faults; 1S=number of first serves won; 2S=number of second serves won; 1SR=number of first serve return points won; and 2SR=number of second serve return points won.

### Athlete Selection

The user picks their team of up to 5 athletes at the beginning of the second round of the tennis tournament using their allotted 100 points and then accumulates points for the entire tournament. Alternate selections are used.

### Scoring

A user is awarded points based on the following actions of his/her athlete: an ace=5 points; and a double fault=−2 points. Additionally, an athlete is eligible for bonus points as follows: winning the match=10 points; each first serve point won=2 points; and each second serve point one=1 point. Tiebreakers are decided by users predicting the total points scored for pre-selected questions. The winning team includes the highest scoring team over rounds 2 through 6 of a tennis tournament.

H. Football

### Player Point Value System (PPVS)

The point cost tier of the athletes is based on their Skill Score Ranking (Power Ranking) which is calculated as follows:

((Yards*Touchdowns)/10)/(Fumbles+2)

where Yards=number of yards run by the athlete; Touchdowns=number of touchdowns scored by the athlete; and Fumbles=the number of fumbles plus the number of interceptions lost by the athlete.

The defense/special team (DST) point cost tier is calculated in the same method using Touchdowns (TD), Sacks, and forced turnovers (Interceptions/Forced Fumbles). Because there are only two DST available, the split is 10 point tier cost for the higher ranked, and 5 point tier cost for the lower ranked.

### Athlete Selection

Four to five individual athletes per team are selected as opposed eight/nine athletes (in a traditional fantasy football game) or fifteen (in an IDP style fantasy football game) athletes. Also, instead of choosing specific defensive players (IDP), a user selects a team's defense/special teams (DST). Trading, cutting and signing athletes have also been eliminated because of the single game nature of the concept.

A user can only form a team based on the two sports teams playing for the specified game. Alternate selections may be made by the user in the event of a needed replacement—selecting an athlete from the same point cost tier that is not currently on the user's team. Tiebreaker questions are used.

### Scoring

Quarterback: 1 point for every 10 yards passed, with a 5 point bonus for over 100 yards passed, a 10 point bonus for over 200 yards passed, and a 15 point bonus for over 300 yards passed. User gets 3 points for every 10 yards run.

Running Back/Wide Receiver/Tight End: 3 points for 10 yards run/caught, with a 6 point bonus for over 100 yards run/caught, and a 12 point bonus for over 200 yards run/caught.

Each offensive touchdown is worth 6 points. Each two-point conversion scored by an offensive player is worth 2 points. Defense: Sacks, interceptions, and forced fumbles (regardless of recovery) are worth 1 point each. Defensive touchdowns or Special Teams touchdowns are worth 4 points. A field goal scored by the defense or special teams is worth 1 point. A safety scored by the defense or special teams is worth 2 points. The user receives the following numbers of bonus points based on the number of points his/her defense surrenders as follows: 0-6 points surrendered=6 points; 7-13 points surrendered=3 points; 14-20 points surrendered=1 point; 21+points surrendered=0 points.

I. Soccer

### Player Point Value System (PPVS)

The PPVS formula is as follows:

(M/10)+G+A+SOG−(Y/2)−R+GS

where M=minutes played by the athlete; G=number of goals scored; A=number of assists; SOG=number of shots on goal; Y=number of yellow cards received; R=number of red cards received; and GS=number of games started.

### Athlete Selection

The user picks their team of up to five athletes before the match starts using their allotted 100 points and then accumulates points for the match. Alternate selections are used.

### Scoring

All athletes: a goal=10 points; an assist=5 points; a shot on goal=2 points; a shot=1 point; a foul suffered=2 points; a foul committed=−1 point; a yellow card=−2 points; and a red card=−5 points.

Goalie: a save=2 points; a goal conceded=−4 points. A user receives the following number of bonus points if his/her goalie: concedes 0 goals=10 points; concedes 1 goal=5 points; and concedes 2 goals=2 points

The winning team has the highest number of points after the match has ended.

Tiebreakers are decided by users predicting who will win the game, how many total shots there will be, and how many yellow cards will be issued.

J. Cricket

### Player Points Value System (PPVS)

The batsman skill score is calculated as follows:

IF (B<10,1,(R*10+4s*4+6s*6)/(M/B)*(SR/100)

where each of the following are the most recent statistics: R=number of runs hit; M=minutes batted; B=balls faced; 4s=number of times an athlete hit 4-runs (if ball touches the ground before crossing the boundary); 6s=number of times an athlete hit 6-runs (if ball crosses the boundary without touching the ground; SR=strike rate (equal to runs/balls faced).

Bowler skill scores are calculated as follows:

(10*M+5*W)/(Econ)+(O*100)/R

where each of the following are the most recent statistics: O=over (a set of six balls bowled from one end of a cricket pitch); M=maiden (an over in cricket during which no runs are scored); R=runs conceded; W=wickets taken; Econ=economy rate (equal to runs/over).

### Scoring

Batsman: runs=10 points; 6s=6 points; 4s=4 points;

Bowlers: maiden=100 points; wicket=50 points; run conceded=−1 point.

### Athlete Selection

After skill scores are calculated, all athletes' (batsmans' and bowlers') skill scores are ranked as follows:

PPVS in the top 7.5%=point cost of 30 points;
PPVS in the top 7.5% to 15%=point cost of 25 points;
PPVS in the top 15% to 25%=point cost of 20 points;
PPVS in the top 25% to 40%=point cost of 15 points;
PPVS in the top 40% to 60%=point cost of 10 points; and
PPVS in the top 60% to 100%=point cost of 5 points.

Each fantasy team much consist of at least three batsman and one bowler.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A system for allowing users to create a fantasy sports team of athletes for virtual participation corresponding to a single real-world sporting event, comprising:
a host computer in communication with a plurality of remote client computers via at least one communications network, said host computer including a processor and non-transitory storage media;
a database resident on the non-transitory storage media, said database comprising a plurality of athlete records each including an athlete's team affiliation and performance statistics;
a user interface for allowing a user to select a plurality of athlete records from said database comprising a virtual team;
a software module resident in the non-transitory storage media of said host computer for execution by said processor thereof, said module comprising computer instructions stored on non-transitory computer media for performing the steps of,
allowing a plurality of users to each select a single real-world sporting event;
allowing a plurality of users to each make selections to compose a virtual team consisting of a subset of athletes participating in said single real-world sporting event;
accumulating performance statistics of said athletes participating in said single real-world sporting event and updating said plurality of athlete records in said database;
accumulating points to said users based on their selected athlete's real-time performance during said single real-world sporting event; and
displaying results from said software module to said user in real-time during said single real-world sporting event.

2. The system according to claim 1, wherein said software module limits selections made via said user interface to a smaller number of athletes than the number of athletes on a team participating in the real-world event.

3. The system according to claim 1, wherein said software module allows selection of a staff of real world athletes from a real world team to play a single virtual position.

4. The system according to claim 1, wherein said software module analyzes points accumulated to said users based on their selected athlete's real-time performance during said single real-world sporting event and identifies a user having a highest total team score based on the real-world performance at that singular sporting event.

5. The system according to claim 1, wherein said software module limits said selections to a pool of real world athletes participating in said single real-world sporting event.

6. The system according to claim 1, wherein said software module requires selection of a plurality of primary athlete records and a plurality of alternate athlete records for athletes that do not play in said real world sporting event.

7. The system according to claim 1, wherein said software module requires each user to answer a plurality of tie-breaker questions, and when said software module analyzes that two teams are tied with highest total team score said software module analyzes said tie-breaker answers to determine a winner.

8. The system according to claim 1, wherein said database of athlete performance statistics is limited to performance statistics for a preceding predetermined amount of time.

9. The system according to claim 1, wherein said database of athlete records is limited to records based on performance statistics for a preceding predetermined number of games.

10. The system according to claim 1, wherein said software module comprises computer instructions stored on non-transitory computer media for performing the additional step of assigning each real-world athlete competing in the selected real world game a point-value prior to allowing a plurality of users to each select a virtual team.

11. A method for virtual participation in a single real-world sporting event, comprising:
storing a plurality of athlete records in a database resident in a non-transitory storage media, each said athlete record comprising a performance statistics and team affiliation of a real world athlete;
allowing a plurality of users to make selections of a plurality of athlete records from said database to compose a virtual team consisting of a subset of athletes participating in said single real-world sporting event;
accumulating performance statistics of said athletes participating in said single real-world sporting event and updating said plurality of athlete records in said database;
accumulating points to said users based on their selected athlete's real-time performance during said single real-world sporting event; and
displaying results from said accumulating step to said user in real-time during said single real-world sporting event.

12. The method according to claim 11, wherein said step of allowing a plurality of users to make selections limits selections made via said user interface to a smaller number of athletes than the number of athletes on a team participating in the real-world event.

13. The method according to claim 11, wherein said step of allowing a plurality of users to make selections comprises allowing a plurality of users to select a staff of real world athletes from a real world team to play a single virtual position.

14. The method according to claim 11, further comprising a step of analyzing points accumulated to said users based on their selected athlete's real-time performance during said single real-world sporting event, and wherein said step of displaying results comprises identifying a player having a highest total team score based on the real-world performance at that singular sporting event.

15. The method according to claim 11, wherein said step of allowing a plurality of users to make selections limits said selections to a pool of real world athletes participating in said single real-world sporting event.

16. The method according to claim 11, wherein said step of allowing a plurality of users to make selections of a plurality of athlete records from said database comprises selecting plurality of primary athlete records and a plurality of alternate athlete records for athletes that do not play in said real world sporting event.

17. The method according to claim 16, further comprising a step of requiring each user to answer a plurality of tie-breaker questions, wherein said step of accumulating points to said users based on their selected athletes' real-time performance during said single real-world sporting event comprises analyzing said tie-breaker answers to determine a winner when two teams are tied for the highest total team score.

18. The method according to claim 11, wherein said step of storing a plurality of athlete records consists of athlete performance statistics for a preceding predetermined amount of time.

19. The method according to claim 11, wherein said step of storing a plurality of athlete records consists of storing athlete performance statistics for a preceding predetermined number of games.

20. The method according to claim 11, further comprising a step of assigning each real-world athlete competing in the selected real world game a point-value prior to the step of allowing a plurality of users to each make selections of a plurality of athlete records.
